(19) United States
(12) Patent Application Publication
(10) Pub. No.: US 2009/0068629 A1
(43) Pub. Date: Mar. 12, 2009

(54) DUAL OUTPUT GRADEBOOK WITH RUBRICS

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: Workman Nydegger;1000 Eagle Gate Tower, 60 East South Temple, Salt Lake City, UT, 84111, US

(21) Appl. No.: 11/851,343

(22) Filed: Sep. 6, 2007

(51) Int. Cl. G09B 5/00

(52) U.S. Cl. 434/353; 434/362

(57) ABSTRACT

A system and method for assessing a student's performance in a course in an online course environment, the method comprising creating rubrics that correlate with course materials for an online course, the rubrics including a scoring schema which is stored in an educational management system, distributing the rubrics from the educational system to a user's computer through a network connection, displaying the rubrics on the user's computer together with their correlating course materials, recording the outcome of a student's performance on the rubrics, the outcome including a grade associated with a student, and transferring the recorded outcome to the educational management system.

### CROSS-REFERENCE TO RELATED APPLICATIONS

Not applicable.

### BACKGROUND OF THE INVENTION

1. The Field of the Invention

The invention generally relates to educational online systems, and more particularly to gradebooks for online systems.

2. The Relevant Technology

Educators are constantly looking for new tools to help them teach more efficiently and effectively. Web-based learning management systems (LMS) and content management systems (CMS) have been increasingly used by corporations, government agencies, and higher education institutions. A LMS is a software package that facilitates the management and delivery of online content to learners, often in order to enable the individualized and flexible access to learning content. Typically, an LMS allows for an online teaching environment, which a CMS is a computer software system that is typically used to manage the storing, controlling, versioning, and publishing of the educational content. Using a combination of the above technologies, several educational systems have been developed in the art that offer flexible online learning solutions for educators.

Due to the flexible and individualized nature of the systems, students and employees can take courses on their own time and at their own pace, in accordance with their various daily commitments, while educators, management, and human resource departments are able to track progress. Further, because the systems may be easily updated and modified, the systems often provide more relevant information than is currently available using traditional teaching tools.

One advantage of these courses is the ability to give students key information they need outside the confines of the traditional university buildings or classrooms. The distance learning students can gain access to the course materials by connecting to the Internet or other global network. Thus, several institutions have implemented online or hybrid courses where the course is administered wholly or partially in the online setting.

Despite these advantages, however, these systems present problems when educators or students are traveling and cannot connect to the corporate LMS or online courses. Likewise, deployed troops have limited connectivity to courses in the field. Many students are on a tight budget and have slow or no connectivity when off campus. And faculty who want to continue to do their work when they are at an offsite event are unable to work when away from their network. Thus, the present systems are limited because they require constant access to the Internet or similar network connection.

One area of particular importance to educators is the ability to easily assess and track student performance throughout the duration of the course using a grade book or similar grading system. This is particularly important in the online education setting, where it may often be difficult for students and teachers to monitor a student's progress during the course of an educational program and provide meaningful feedback to students. Thus, there is a need for an efficient, user-friendly method of grading student performance in an online educational system.

### BRIEF SUMMARY OF THE INVENTION

The invention generally relates to online systems for educational course materials, and more particularly, to systems for distributing online courses with periodic synchronization and distribution of course information.

One aspect of the present invention is a method of distributing educational information in a computing environment, including an educational management system comprising a server and educational information. The method includes allowing a user to connect a computing device to the educational management system server through a network connection, transferring a plurality of educational information from the educational management system to the computing device, and performing a sync operation when the computing device is connected to the educational management system, wherein the plurality of educational information includes data and computer programs that are capable of performing computing functions in the computing device while not connected to the network.

Another aspect of the present invention is a system for distributing educational information, comprising a plurality of user computing devices capable of connecting to an education management system through a network connection, an education management system comprising a server capable of sending and receiving a plurality of educational information with the user computing devices, wherein the plurality of educational information includes data and computer programs that are capable of performing computing functions on the user computing devices when the user computing devices are not connected to the education management system through the network.

Advantageously, the present invention allows users of the system to access and utilize the educational content while offline, greatly expanding the usefulness and efficiency of online current educational systems. Aspects of the system may be used by students, educators, and course administrators alike. Thus students can continue learning regardless of their present network interconnectivity, and teachers and course administrators can continue to create and develop new content beyond the confines of the classroom.

These and other aspects of the present invention along with additional features and advantages will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-B are block diagrams illustrating an exemplary system capable of performing the invention;

FIG. 2 is a block diagram illustrating the method of the present invention;

FIG. 3 is a block diagram illustrating the method of the invention in a networked computing system including a teacher, student, and education management system;

FIG. 4 is an illustration of an exemplary rubric that may be displayed on a student's computer in association with the invention;

FIG. 5 is an illustration of an exemplary rubric that may be displayed on a teacher's computer in association with the invention;

FIG. 6 is an illustration of an exemplary assignment gradebook that may be displayed on a teacher's computer in association with the invention; and

FIG. 7 is an illustration of an exemplary course gradebook that may be displayed on a teacher's computer in association with the invention.

### DETAILED DESCRIPTION OF THE VARIOUS EMBODIMENTS

The principles of the various embodiments are described using the structure and operation of examples to illustrate the present invention. The various embodiments provide the capability to utilize the assessment aspects of the online courses with no or intermittent Internet access and enables the periodic synchronization of information, such as course materials, tests, bulletin boards, grade books, quizzes, discussion threads, message boards, and the like.

As used herein, the term “user” may be used to describe students, employees, content providers, educators, employers, or course administrators who are accessing the education management system using a computer. The computer may be any specific of general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the education management system using the same computer.

In each case, the distributed nature of the present invention allows the various users to utilize aspects of the educational system while offline, meaning that the users may continue working regardless of their present interconnectivity. As discussed more specifically below, the system operates by distributing various learning software onto the user computer when the user is connected to the system, wherein the learning software continues being used when the user is no longer connected to the system. Later, when the user connects to the system, the user's computer and the educational system perform a syncing operation. During the syncing operation, the educational system receives any work or new data that has been created or modified while the user's computer was offline and the user's computer receives any new information or data available on the educational system.

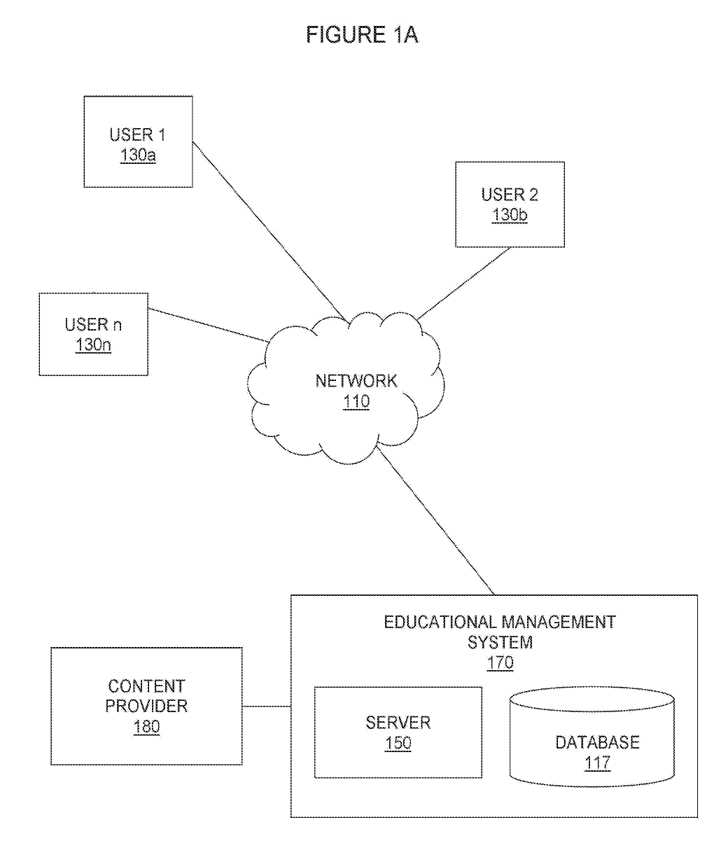

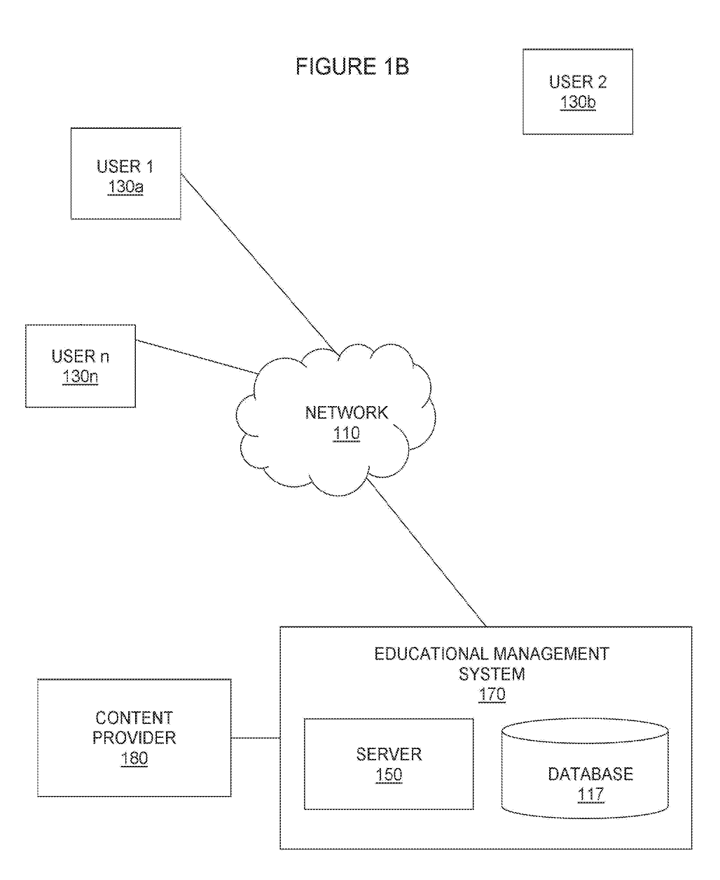

FIG. 1A is a block diagram illustrating an exemplary system capable of performing the present invention. As shown, the system includes a number of users, “User 1” 130a through “User n” 130n, who are connected to an educational management system 170 via a network connection 120. As will be understood by one of ordinary skill in the art, the network 120 may be any local or global network, including a LAN, WAN, wireless network, internet connection, and the like.

In one embodiment of the invention, the education management system 170 includes a server 150 capable of sending and receiving communications and data via the network 120, along with a database 160 capable of storing a plurality of educational software and data. In addition, the database 160 can be used to store data relating to the user identification. As will be understood by one of ordinary skill in the art, any number of configurations may be used to create an education system, including systems using a series of interconnected databases, computers, and servers.

In one example, the education management system 170 is connected to a content provider 180. Here, the content provider 180 may be a third party content provider, who is responsible for creating various course software. In contrast, the content provider 180 may be part of the education management system 170. Further, the content provider 180 may be an educator or course developer who connects to the education management system 170 as a user.

According to one embodiment of the present invention, the system may use a mechanism such as a bit torrent or related protocol wherein the system may use a peer-to-peer communications protocol to share the educational content. Using such systems, the system typically breaks down any content into a number of smaller, identically-sized pieces, which are distributed among a plurality of users of the system who require the educational content. Then using a series of P2P connections, the files may be sent and received by the users over a period of time. Advantageously, this method of distribution is capable of distributing large amounts of data widely without requiring the content provider 180 or server 150 to incur the large costs of hardware, hosting, and bandwidth resources that would otherwise be required to distribute the educational content. Further, this embodiment would allow the “trickling” of downloads, meaning that in situations where the content to be downloaded is a large file, the system may permit the user to download smaller discrete portions of the content, instead of requiring a constant connection for the duration of the downloading process. A scheduled download can populate the user's computers with course content over a controlled distribution.

Thus, in situations where a large number of identical files need to be distributed to a number of users of the system, say at the beginning of a semester or session, when each student of the program requires the content associated with the course, the present invention may be effectively distributed without overwhelming the education management system 170.

FIG. 1B illustrates the ability of the present invention to be used when a user, here “User 2” 130b is no longer connected to the education management system 170. As described more fully below, one advantage of the present invention is the ability to transfer or distribute software and/or data onto “User 2's” 130b computer which enable “User 2” 130b to continue using the educational software when the computer is not connected to the management system 170. According to the invention, when “User 2” 130b later establishes a connection with the educational management system 170, such as the connection shown in FIG. 1A, the system 170 will perform a syncing operation, wherein it will send and receive data from the “User 2” computer 130b until both the system 170 and the “User 2” 130b have updated information.

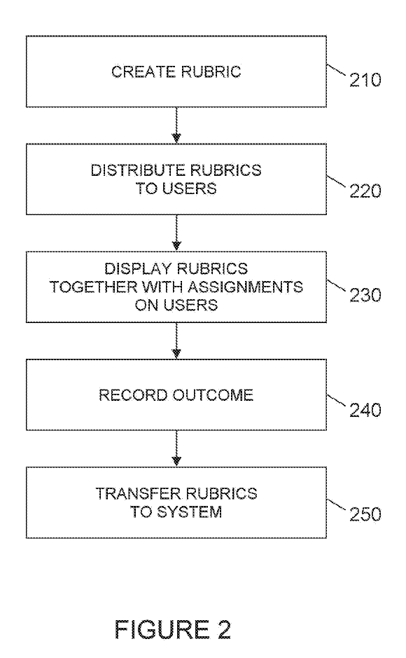

FIG. 2 is a block diagram illustrating a method for performing the present invention in a networked computer environment. At step 210, a teacher creates a rubric for scoring educational content and stores it in the education management system. The rubric is used to assess a student's performance on papers, projects, essays, tests, quizzes, or assignments. Typically a rubric is comprised of criteria and standards that are linked to learning objectives. For example, a rubric may divide the total points possible on a particular assignment into categories such as comprehension of a topic, the completion of the assignment, the completion of the assignment by a specified deadline or the like.

One aspect of the invention is that while the user is working offline, the system retains the learning functions. The user, for instance, is able to study course content and respond to bulletin board messages when working offline. Similarly, educators and course administrators are able to create or combine new course material, respond to bulletin board messages, and grade assignments or tests while offline. Later, when a connection is available and the user logs into the network, the user can upload the work he or she has completed while offline and check for new course material. The system can accommodate multiple users from various learning environments that are leveraged by schools. The system can also track course delivery.

Advantageously, distributed learning enables the important components of an e-learning infrastructure to be distributed where and when needed, so that students, faculty, and workers that are not connected to the network can continue their learning and education anytime, anywhere. The users can review for an exam, continue accessing or building a SCORM-based course, respond to a discussion thread, view a recording of a missed class, create new content, or grade digitally turned-in assignments without the need for network access. Distributed learning extends the usefulness and scope of the present e-learning systems.

The system can support a variety of offline teacher support programs, including a grade book or spreadsheet-like application which allows an educator to manage all students and their grades for each gradable object. Using similar techniques, the system enables a teacher to download any completed work, including assignments, quizzes, or tests that have previously been completed and submitted to the system by users who are students.

In accordance with the distributed learning environment described in FIGS. 1A and 1B, at step 220, the rubric is distributed to users of the education system who are enrolled in the course. According to one embodiment of the system, the rubric is distributed to both students and teachers alike.

At step 230, the rubric is displayed on the user's computer at the same time that the associated course material is displayed on the user's computer. In the scenario where the user is a student, this means that the student is able to simultaneously review the rubric while completing the material. Advantageously, this allows the students to consider the grading criteria included in the rubric when completing any coursework. This allows the users to have a clearer understanding on how to proceed with their work and ensure that they have included or addressed any issues that are included in the rubric. In the scenario where the user is a teacher, the rubric may be displayed simultaneously with the student's completed course material, allowing the teacher to grade the material in one portion of the computer display while viewing the material in another portion of the computer display.

At step 240, the scored rubric is uploaded to the education system. At step 250, the scored rubric is distributed to the student so that the student may review his or her grade and any comments that the teacher may have recorded in the rubric.

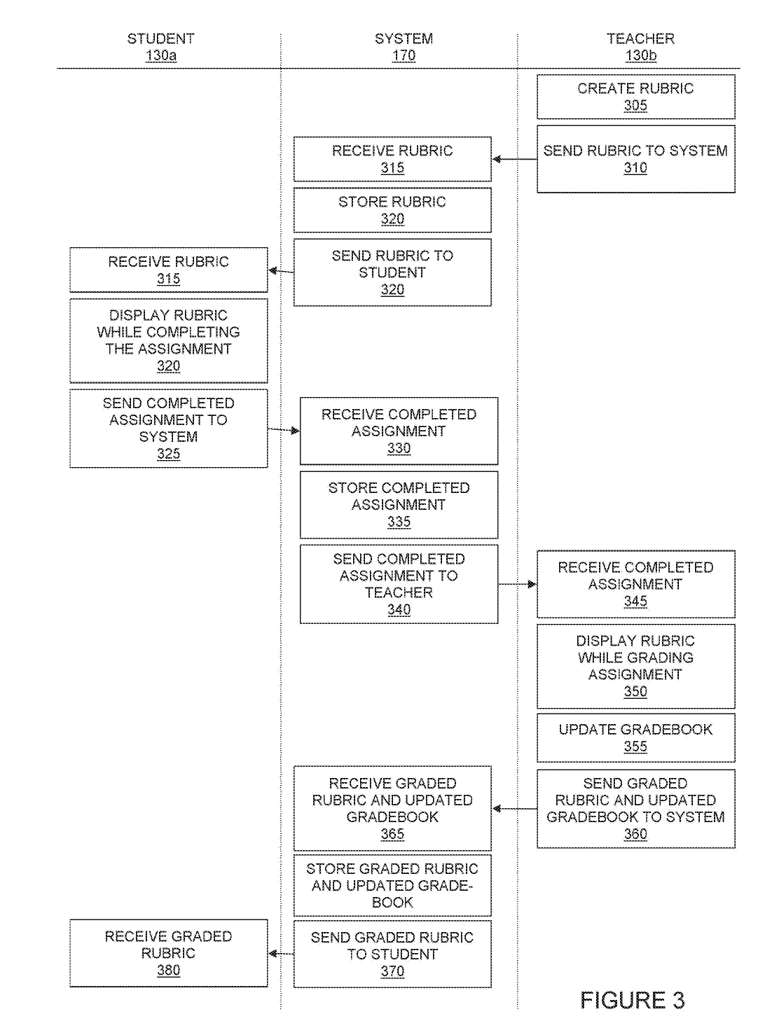

FIG. 3 is a flow chart indicating an exemplary method of the invention in the environment described in FIGS. 1A and 1B. The flow chart illustrates a user who is a teacher 130b who is connected to the online education management system 170. The system 170 is also connected to a user who is a student 130a via a network connection. At step 305, the teacher 130b creates a rubric. During the creation process, the rubric is associated with a specific quiz, assignment, essay, project, test, or other educational content. At step 310, the teacher submits the rubric to the server.

As previously mentioned, the present invention may be used in a distributed online educational system, meaning that the teacher's computer 130b may locally store the completed rubric until the computer connects to the online education management system 170 as described above. When the connection is established, the teacher's computer 130b may send/receive data and/or perform a syncing operation during which the rubric may be sent 310 to the system 170. Using similar methods, the system 170 may send or receive data from the teacher 130b and student 130a during the various steps described in FIG. 3, meaning that the teacher 130b and student 130a need not be continuously connected to the system 170.

At step 315, the system 170 receives the rubric from the teacher 130b. Next, the system 170 stores the rubric and sends 320 the rubric to the student 130a. The student 130a receives 315 the rubric. At step 320, the rubric is displayed on the user's 130a computer so the student 130a may review the grading criteria for the associated assignment, quiz, test, project, or other course content. As previously mentioned, this enables the student 130a more effectively complete the coursework. Then the student completes the assignment and submits 325 it to the system 170.

As previously described, once the student 130a is connected to the system 170, the completed assignment is sent 325 and received 330 by the system 170. The system 170 then stores 335 the completed assignment. When a network connection is then established with teacher 130b, the system sends 340 the completed assignment to the teacher 130b. The teacher 130b then receives 345 and is able to grade the student's 130a completed work. At step 350, the completed work is displayed simultaneously with the rubric. Advantageously, this allows the teacher 130b to review the completed work and enter the corresponding score in the same window, meaning that the teacher 130b will not have to toggle between screens or windows and may easily access all the information required to grade the material at the same time.

Once the grading process is completed, the teacher may submit the rubric with its accompanying scores to the system. The system then updates the gradebook 355 on the teacher's 103b computer. At step 360, a network connection is established between the teacher 130b and the system 170 and the graded rubric and the updated grade data are sent to the system 170. Next, at step 365, the system receives the graded rubric and the updated scores. The updated data is stored 370 in the system and may be sent 375 to the student 130a. At step 380, the student 130a receives the updated rubric and is able to review his or her score along with any comments that the teacher 130b may have made relating to the student's 130a work.

Thus, one aspect of the present invention is an increased feedback mechanism between a student and a teacher in an online setting. Students are able to review the teacher's rubrics while they are completing an assignment, enabling them to better understand and address the teacher's expectations while they work, and teachers are able to easily grade the coursework and give scores and feedback that are meaningful to the student. Thus, one advantage of the present invention is an individualized feedback mechanism between teachers and students.

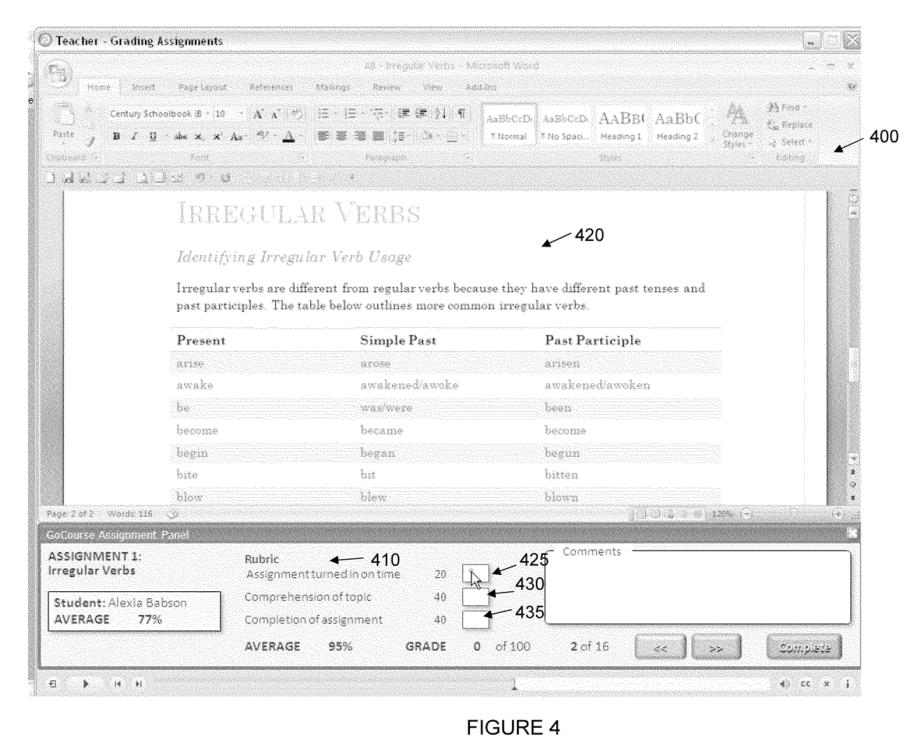

FIG. 4 is a exemplary illustration showing a sample display 400 for a student user (here, “Alexia Babson”). According to aspects of the invention, the student is able to view the grading rubric 410 while simultaneously completing “Assignment 1” 420. Here, the rubric 410 indicates that the student will be given points based on turning in the assignment on time 425, for fully comprehending the topic 430, and for completing the assignment 435. Using this display, the student is notified that completing the entire assignment is as important as fully comprehending the subject matter. Further, the student is notified that the teacher is also grading the student based on the timeliness of completion.

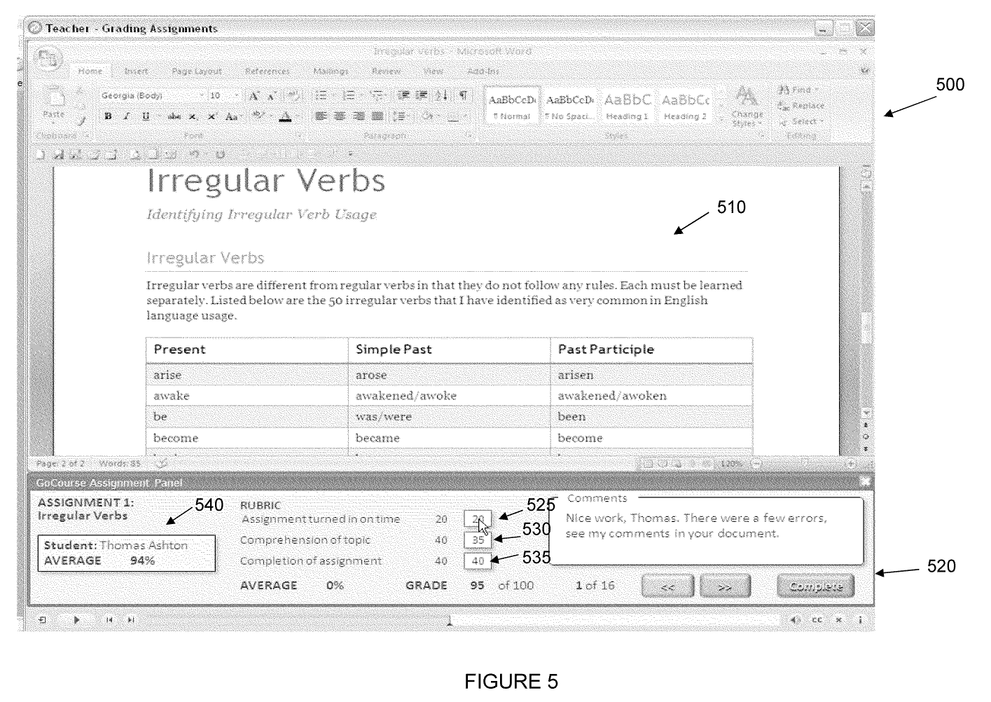

FIG. 5 is an exemplary illustration showing a sample display 500 for a teacher. As illustrated in FIG. 5, the present invention allows the teacher to grade a student's (here, “Thomas Ashton”) assignment while simultaneously viewing the grading rubric 520. As shown in FIG. 5, the rubric 520 may contain user interface buttons that allow the teacher to input scores for the assignment 510. Here, the rubric 520 includes input boxes 525, 530, and 535 for each scored portion of the rubric. The rubric 520 also includes a student name 540 indicating which student the assignment 510 belongs to. In addition, the rubric 520 may include a text box 545 where the teacher may enter in comments for the student. Furthermore, the rubric may be modified to hide or eliminate the student name 540 in order to enable anonymous grading. As understood by one of skill in the art, the rubric may include more or less user inputs, such as check boxes, sliding scales, thumbs up/thumbs down, letter grades, pass/fail indicators and the like.

As previously described, once the teacher has completed the grading process, he or she may submit the graded rubric to the educational management system 170, where the scores may be stored. In addition, the graded rubric and its accompanying comments may be sent to the student for his or her review. Using this system, the student may receive helpful feedback that will enable them to better understand the scoring process and help them to identify any areas that need to be improved.

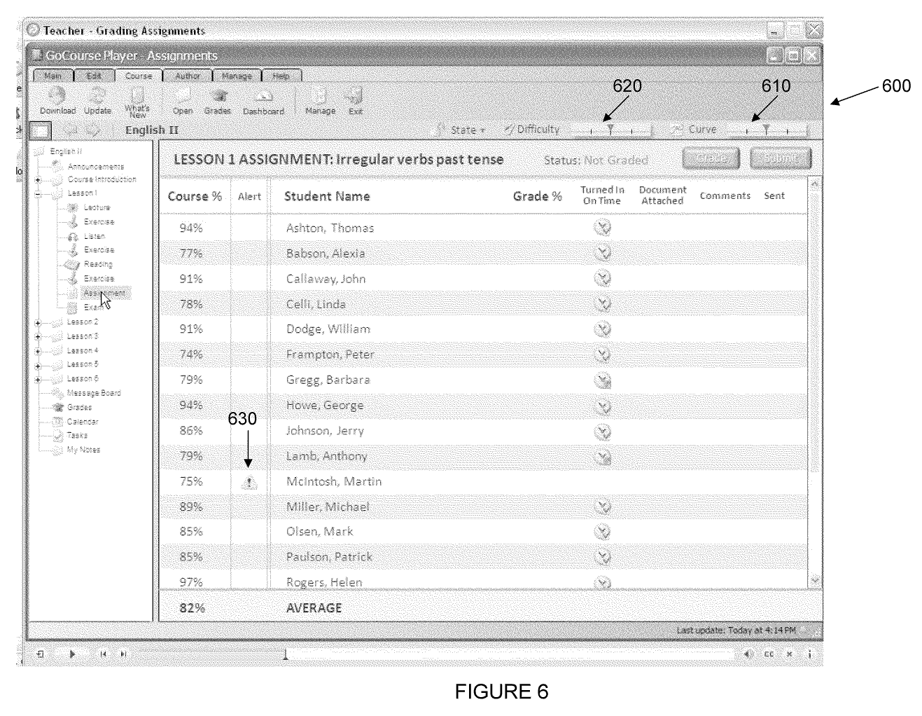

FIG. 6 illustrates another aspect of the invention. Using the scores entered into the rubrics and other information associated with the course materials using the method described above, the educational management system 170 is able to generate a gradebook for the teacher. FIG. 6 illustrates an exemplary gradebook 600 for a single assignment. As shown, the gradebook includes a listing of each student in the course along with a grade percentage for each assignment, along with administrative information such as whether the assignment was turned in on time, whether the teacher has the assignment stored locally on his or her computer, whether comments have been stored, and whether the grades have been sent to the educational management system 170. In one embodiment, the gradebook may also include a difficulty adjuster 620 and a curve adjuster 610, which allow the teacher to review and/or modify the range of scores on a particular assignment. Here, the gradebook also includes an overall course percentage along with an alert or alarm to notify the teacher if a student's performance falls below a series of defined parameters. For example, in FIG. 6, the student “Martin McIntosh” failed to turn in the “Lesson 1 Assignment” and has a course percentage below a predefined level, so there is an alert icon 630 next to his name.

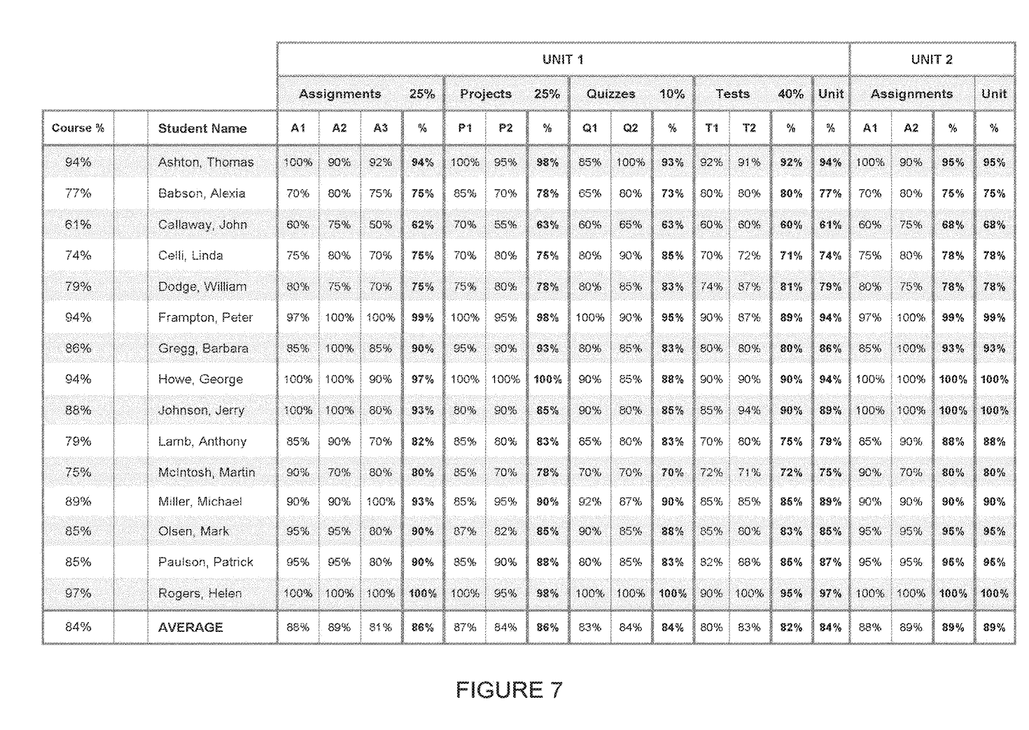

FIG. 7 is an exemplary gradebook for the entire progress of a course. One advantage of the present system is that the gradebook is automatically updated with the scores from the graded rubrics. Thus, the teacher is only required to enter the scores in the educational management system 170 one time for each graded item in order to generate a meaningful gradebook. This is unlike conventional scoring systems where the teacher may be required to enter a single score in many different locations. Here, the teacher has indicated that the course grade will be based on assignments (25%), projects (25%), quizzes (10%), and tests (10%). As will be understood by one of skill in the art, these percentages are used by way of illustration only and any different combination or designation may be used to generate the overall course grade.

Using the assigned percentage weightings for each type of coursework together with the stored grades in the educational management system 170, a final course percentage may be generated for each student. Thus, one advantage of the present system is the ability to automatically convert the points possible format used in the rubrics into a series of percentages in the gradebook.

According to one embodiment of the present invention, the course gradebook may also be divided into units or similar modules. This may be useful in situations where the course is divided over a series of terms, quarters, or semesters, and the teacher desires to generate a course grade that includes a subset of course work. For example, in the display shown in FIG. 7, the teacher has designated that the reported course grade should only include the work completed in “Unit 1,” and not the work completed in “Unit 2.”

The ability to divide the course into units or modules may be especially useful in situations such as concurrent enrollment where a high school student gets both high school and college credit for advanced courses. In such arrangements, the high school often issues grades every six to eight weeks while the college issues a grade at upon completion of the course at the end of the semester. By enabling instructors and course administrators to divide the course activities into sections, grades may be issued to the high school according one set of divisions while reporting only a final grade incorporating all activities to the college.

Thus, one aspect of the invention is an easy and efficient method of using rubrics to grade course work. Using the rubrics, the teachers may notify students of the grading criteria for course work while the students are completing the work. This system allows the students to complete their work so as to meet the grading criteria and the teacher's expectations. Then using the rubrics in a dual display with the student's work that has been transferred to the computer's computer, the teacher is able to grade each student's work on his or her schedule without a continuous network connection. Then once the teacher has connected to the education management system, the scores and comments are uploaded and stored. The teacher's graded rubric may then be sent to the student for him/her to review and the scores may be used to generate a gradebook. This system allows both the student and the teacher to download the course materials that they need so that they can continue to work at their own pace.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment for online courses, a method for assessing a student's performance in a course, the method comprising:
creating rubrics that correlate with course materials for an online course, the rubrics including a scoring schema which is stored in an educational management system;
distributing the rubrics from the educational system to a user's computer through a network connection;
displaying the rubrics on the user's computer together with their correlating course materials;
recording the outcome of a student's performance on the rubrics, the outcome including a grade associated with a student; and
transferring the recorded outcome to the educational management system.

2. The method according to claim 1, wherein the step of creating rubrics includes assigning a scoring schema with numeric values to define a student's performance.

3. The method according to claim 2, wherein the step of creating rubrics includes assigning a scoring schema to define a student's performance on a course assignment, test, quiz, or project.

4. The method of claim 1, wherein recording the outcome of a student's performance includes recording at least one of a number of correct answers, a letter grade, a total number of points received, percentage, a completion indicator, and a pass/fail expression.

5. The method of claim 1, the method further comprising generating a course gradebook for a student enrolled in the course that includes a tally of outcomes for a plurality of course materials.

6. The method of claim 5, wherein generating a course gradebook further includes grouping the course materials into a unit, term, or semester.

7. The method of claim 5, wherein generating a course gradebook further includes generating a course outcome for the student.

8. The method of claim 7, wherein the course outcome is comprised of a mathematical composition of the outcomes for a plurality of course materials.

9. The method of claim 5, wherein the tally of outcomes are expressed as a percentage, letter grade, pass/fail expression, total points received, or complete/incomplete expression.

10. The method of claim 1, wherein the assessment of the student's performance in a course may be performed before or after the completion of the course.

11. In a computing environment for online courses, a method for tracking a student's progress through the course, the method comprising:
creating rubrics that correlate with course materials for an online course, the rubrics including a scoring schema which is stored in an educational management system;
distributing the rubrics from the educational system to a user's computer through a network connection;
displaying the rubrics on the user's computer together with their correlating course materials;
recording the outcome of a student's performance, the outcome including a grade associated with a student;
transferring the outcome of the student's performance to the educational management system; and
comprising generating a course gradebook for the student that includes a tally of outcomes for a plurality of course materials;
wherein the course materials include course assignments, tests, quizzes, and projects.

12. The method according to claim 11, wherein the step of creating rubrics includes assigning a scoring schema with numeric values to define a student's performance.

13. The method of claim 11, wherein recording the outcome of a student's performance includes recording at least one of a number of correct answers, a letter grade, a total number of points received, percentage, a completion indicator, and a pass/fail expression.

14. The method of claim 11, wherein generating a course gradebook further includes grouping the course materials into a unit, term, or semester.

15. The method of claim 11, wherein generating a course gradebook further includes generating a course outcome for the student.

16. The method of claim 15, wherein the course outcome is comprised of a mathematical composition of the outcomes for a plurality of course materials.

17. The method of claim 11, wherein the tally of outcomes are expressed as a percentage, letter grade, pass/fail expression, total points received, or complete/incomplete expression.

18. The method of claim 11, wherein the assessment of the student's performance in a course may be performed before or after the completion of the course.

19. A system for assessing a student's performance in a computing environment for online courses, the system comprising:
a content provider including course materials and grading rubrics for an online course to be accessed by a user's computer;
an educational management system including a server and a database, the educational system being configured to associate a grading rubric with a course material, with the grading rubric containing a set of values corresponding to a student's performance on the course material; and
a network connection linked to the educational management system and configured to distribute the course materials from the content provider to the user's computer, the network connection providing a link to transfer information between the educational management system and a user's computer;
wherein the information transferred between the educational management system and the user's computer is associated with a particular course and user in the database, the grading rubric and course material being displayed together on the user's computer, and student performance being stored on the server.

20. In a computing environment for online courses, a method for tracking a student's progress through the course, the method comprising:
creating rubrics that correlate with course materials for an online course, the rubrics including a scoring schema which is stored in an educational management system;
distributing the rubrics from the educational system to a user's computer through a network connection;
displaying the rubrics on the user's computer together with their correlating course materials;
recording the outcome of a student's performance, the outcome including a grade associated with a student;
transferring the outcome of the student's performance to the educational management system; and
comprising generating a course gradebook for the student that includes a tally of outcomes for a plurality of course materials;
dividing the outcomes in the course gradebook into a plurality of grading periods;
wherein the course materials include course assignments, tests, quizzes, and projects.
